(19) United States
(12) Patent Application Publication
(10) Pub. No.: US 2025/0363699 A1
(43) Pub. Date: Nov. 27, 2025

(54) IMAGE GENERATION METHOD AND APPARATUS, AND ELECTRONIC DEVICE AND STORAGE MEDIUM

(71) Applicant: Beijing Zitiao Network Technology Co., Ltd., Beijing (CN)

(72) Inventor: Bingchuan LI, Beijing (CN)

(21) Appl. No.: 19/295,417

(22) Filed: Aug. 8, 2025

Related U.S. Application Data
(63) Continuation of application No. PCT/CN2024/075427, filed on Feb. 2, 2024.

(30) Foreign Application Priority Data
Feb. 10, 2023 (CN) 202310133745.4

(51) Int. Cl. G06T 11/60; G06V 40/16

(52) U.S. Cl. CPC G06T 11/60; G06V 40/174

(57) ABSTRACT

An image generation method and apparatus, an electronic device, and a storage medium are provided. A second target parameter is generated based on a first target parameter corresponding to a first image and a target expression modulation coefficient, and the second target parameter is input into an image generation model to generate a second image, so that the second image matching the first image and having a target expression can be obtained.

### CROSS-REFERENCE TO RELATED APPLICATION(S)

The present application is a Continuation Application of International Patent Application No. PCT/CN2024/075427, filed Feb. 2, 2024, which claims priority to Chinese Patent Application No. 202310133745.4, filed on Feb. 10, 2023 and entitled “IMAGE GENERATION METHOD AND APPARATUS, ELECTRONIC DEVICE, AND STORAGE MEDIUM”, which is incorporated herein by reference in its entirety.

### FIELD

The present disclosure relates to the field of computer technologies, and in particular, to an image generation method and apparatus, an electronic device, and a storage medium.

### BACKGROUND

In some application scenarios, users may intend to adjust expressions in videos or photos (for example, remove expressions or add other expression effects). In a related technical solution, an artificial intelligence model is usually used to add an expression effect to an image.

### SUMMARY

The Summary is provided to give a brief overview of concepts, which will be described in detail later in the Detailed Description section. The Summary is neither intended to identify key or necessary features of the claimed technical solutions, nor is it intended to be used to limit the scope of the claimed technical solutions.

In a first aspect, according to one or more embodiments of the present disclosure, an image generation method is provided. The image generation method includes:
obtaining a first image;
generating, based on a first target parameter corresponding to the first image and a target expression modulation coefficient, a second target parameter; and
inputting the second target parameter into an image generation model to generate a second image, where the second image is an image matching the first image and having a target expression.

In a second aspect, according to one or more embodiments of the present disclosure, an image generation apparatus is provided. The image generation apparatus includes:
a first image obtaining unit configured to obtain a first image;
a second parameter determination unit configured to generate a second target parameter based on a first target parameter corresponding to the first image and a target expression modulation coefficient; and
a second image generation unit configured to input the second target parameter into an image generation model to generate a second image, where the second image is an image matching the first image and having a target expression.

In a third aspect, according to one or more embodiments of the present disclosure, an electronic device is provided. The electronic device includes: at least one memory and at least one processor, where the memory is configured to store program code, and the processor is configured to invoke the program code stored in the memory to cause the electronic device to perform the method according to one or more embodiments of the present disclosure.

In a fourth aspect, according to one or more embodiments of the present disclosure, a non-transitory computer storage medium is provided. The non-transitory computer storage medium stores program code that, when executed by a computer device, causes the computer device to perform the method according to one or more embodiments of the present disclosure.

According to one or more embodiments of the present disclosure, the second target parameter is generated based on the first target parameter corresponding to the first image and the target expression modulation coefficient, and the second target parameter is input into the image generation model to generate the second image, so that the second image matching the first image and having the target expression can be obtained. According to the method provided in the embodiments of the present disclosure, paired images can be generated in batches for subsequent processing.

### BRIEF DESCRIPTION OF THE DRAWINGS

The foregoing and other features, advantages, and aspects of embodiments of the present disclosure become more apparent with reference to the following detailed description of embodiments and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an image generation method according to an embodiment of the present disclosure;

FIG. 2 is a flowchart of a training method of a target model according to an embodiment of the present disclosure;

FIG. 3 is a flowchart of an image generation method according to another embodiment of the present disclosure;

FIG. 4 is a flowchart of a training method of a target expression model according to an embodiment of the present disclosure;

FIG. 5 is a schematic diagram of a structure of an image generation apparatus according to an embodiment of the present disclosure; and

FIG. 6 is a schematic diagram of a structure of an electronic device according to an embodiment of the present disclosure.

### DETAILED DESCRIPTION OF EMBODIMENTS

In a related technical solution, an artificial intelligence model is usually used to add an expression effect to an image. However, this means that a quantity of images and a quantity of images matching the images and having target expressions are required as training sample pairs (composite “paired images”), to train the artificial intelligence model. However, the paired images are often difficult to obtain.

In addition, a conventional technical solution for generating an expression effect is prone to an erroneous result when applied to an image with an exaggerated expression (for example, showing teeth).

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the steps described in implementations of the present disclosure may be performed in different orders, and/or performed in parallel. Furthermore, additional steps may be included and/or the execution of the illustrated steps may be omitted in the implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. The term “in response to” and a related term mean that a signal or event is affected by another signal or event to an extent, but is not necessarily fully or directly affected. If an event x occurs “in response to” an event y, x may respond directly or indirectly to y. For example, the occurrence of y may finally lead to the occurrence of x, but there may be other intermediate events and/or conditions. In other situations, the occurrence of y may not necessarily lead to the occurrence of x, that is, even if y has not occurred, x may occur. Moreover, the term “in response to” may also mean “at least partially in response to”.

The term “determine” broadly encompasses a wide variety of actions, which may include obtaining, computing, calculating, processing, deriving, investigating, looking up (for example, looking up in a sheet, a database, or other data structures), ascertaining, or similar actions, and may further include receiving (for example, receiving information), accessing (for example, accessing data in a memory), or similar actions, and parsing, selecting, choosing, establishing, and similar actions, and the like. Related definitions of the other terms will be provided in the description below.

It can be understood that the data (including, but not limited to, the data itself and access to or use of the data) used in the technical solutions shall comply with the provisions of relevant laws and regulations.

It can be understood that, before the use of the technical solutions disclosed in the embodiments of the present disclosure, the user shall be informed of the type, range of use, use scenarios, and the like of personal information used in the present disclosure in an appropriate manner in accordance with the relevant laws and regulations, and the authorization of the user shall be obtained. For example, in response to receiving an active request from the user, prompt information is sent to the user, to explicitly prompt the user that the requested operation will require access to and use of the personal information of the user, so that the user can autonomously choose, based on the prompt information, whether to provide the personal information to software or hardware such as an electronic device, an application program, a server, or a storage medium that performs an operation of the technical solution of the present disclosure.

In an optional but non-limiting implementation, in response to receiving the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that, an image generated according to the method provided in each embodiment of the present disclosure should be processed in accordance with the provisions of relevant laws and regulations. For example, a technical measure may be taken in accordance with the provisions to add an identifier that does not affect use of the user, or a prominent identifier is placed at a proper location and in a proper area in accordance with the regulations, to prompt the public with deep composite.

It can be understood that the above process of notifying and obtaining user authorization and image processing is only illustrative and does not constitute a limitation on the implementations of the present disclosure, and other manners that satisfy the relevant laws and regulations may also be applied in the implementations of the present disclosure.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

For the purpose of the present disclosure, the phrase “A and/or B” means (A), (B), or (A and B). The names of messages or information exchanged between a plurality of apparatuses in the implementations of the present disclosure are used for illustrative purposes only, and are not used to limit the scope of these messages or information.

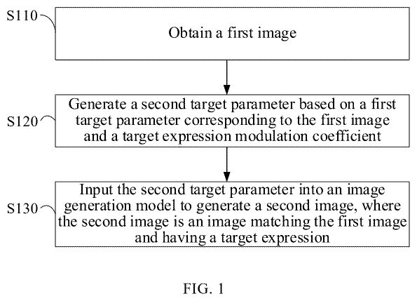

Referring to FIG. 1, FIG. 1 is a flowchart of an image generation method 100 according to an embodiment of the present disclosure. The method 100 includes step S110 to step S130.

Step S110: obtain a first image, for example, a face image.

Step S120: generate, based on a first target parameter corresponding to the first image and a target expression modulation coefficient, a second target parameter.

Step S130: input the second target parameter into an image generation model to generate a second image, where the second image is an image matching the first image and having a target expression.

In some embodiments, the first target parameter may be input into the image generation model to obtain the first image. The image generation model may include, for example, a generative adversarial network. The generative adversarial network may generate an image based on random noise that follows a Gaussian distribution, and a trained generative adversarial network may be used to obtain artificial images through compositing, where the artificial images is difficult to distinguish from real images. In a specific implementation, the generative adversarial network used may be a style-based generative adversarial network, and can separate a high-level attribute (a posture or an identity) from a random change (such as a freckle or hair), to control an attribute of a specific scale in a generated image. The first target parameter may be a randomly determined vector that follows an artificially selected prior probability distribution. For example, the first target parameter may be a random vector that follows the Gaussian distribution. For example, in a process of generating paired images each time, a vector z may be randomly sampled from the Gaussian distribution as the first target parameter, so that a different first image and a second image corresponding to the first image can be generated each time.

It should be noted that the image generation model for obtaining the first image and a generation model for obtaining the second image may be the same model or identical models.

In this embodiment, the first target parameter is modulated by using the target expression modulation coefficient, so that the generated second image, based on the first image, has a target expression corresponding to the target expression modulation coefficient. In some embodiments, the target expression modulation coefficient includes a weight coefficient for adjusting a weight of an input parameter and a bias coefficient.

In this case, according to one or more embodiments of the present disclosure, the second target parameter is generated based on the first target parameter corresponding to the first image and the target expression modulation coefficient, and the second target parameter is input into the image generation model to generate the second image, so that the second image matching the first image and having the target expression can be obtained. According to the method provided in the present disclosure, paired images may be generated in batches for subsequent processing. For example, a large batch of paired images may be used as training sample pairs to train an expression model. However, the present disclosure is not limited thereto.

In some embodiments, a preset target expression coefficient is input into a target model to generate the target expression modulation coefficient. For example, if the target expression coefficient is a neutral expression coefficient, the generated second image is an image obtained after an expression is removed from the first image. If the target expression coefficient is a smiley expression coefficient, the generated second image is an image obtained after a smiley expression is added to the first image.

In a specific implementation, the target model may include a multi-layer perceptron and two convolutional neural networks, one for generating the weight coefficient and the other for generating the bias coefficient. However, the present disclosure is not limited thereto.

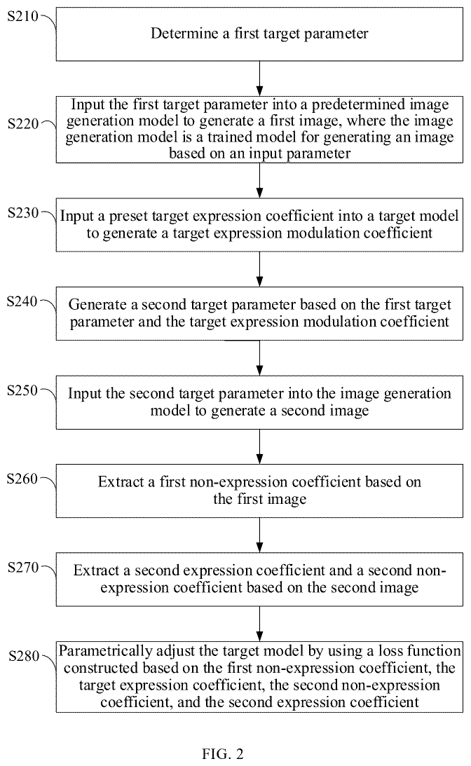

Referring to FIG. 2, FIG. 2 is a flowchart of a training method 200 of a target model according to an embodiment of the present disclosure. The method 200 includes step S210 to step S280.

Step S210: Determine a first target parameter.

Step S220: Input the first target parameter into a predetermined image generation model to generate a first image. The image generation model is a trained model for generating an image based on an input parameter.

In some embodiments, the image generation model may include a generative adversarial network. The generative adversarial network may generate an image based on random noise that follows a Gaussian distribution, and a trained generative adversarial network may be used to obtain artificial images through compositing, where the artificial images is difficult to distinguish from real images. In a specific implementation, the generative adversarial network used may be a style-based generative adversarial network, and can separate a high-level attribute (a posture or an identity) from a random change (such as a freckle or hair), to control a attribute of a specific scale in a generated image.

In some embodiments, the first target parameter may be a randomly determined vector that follows an artificially selected prior probability distribution. For example, the first target parameter may be a random vector that follows the Gaussian distribution. For example, during each training iteration, a vector z may be randomly sampled from the Gaussian distribution as the first target parameter.

Step S230: input a preset target expression coefficient into a target model to generate a target expression modulation coefficient.

Step S240: generate, based on the first target parameter and the target expression modulation coefficient, a second target parameter.

Step S250: input the second target parameter into the image generation model to generate a second image.

In some embodiments, the target expression coefficient may be determined based on steps of: obtaining a target image including the target expression; and extracting the target expression coefficient based on the target image. For example, a real image with a neutral expression (no expression) may be obtained, and a neutral expression coefficient may be extracted from the neutral image by using a parameter extractor of a 3D deformation statistical model.

The target model is used to generate the target expression modulation coefficient based on the input target expression coefficient, and the target expression coefficient is used to modulate the input parameter of the image generation model, thereby assigning relevant information of the target expression to the input parameter through modulation. In turn, it is expected to cause the image (that is, the second image) generated by using the image generation model to have the target expression corresponding to the target expression coefficient.

In some embodiments, the target expression modulation coefficient includes a weight coefficient for adjusting a weight of an input parameter and a bias coefficient. In a specific implementation, the target model may include a multi-layer perceptron and two convolutional neural networks, one for generating the weight coefficient and the other for generating the bias coefficient. However, the present disclosure is not limited thereto.

In some embodiments, a first intermediate target parameter may be first generated based on the first target parameter and then the first intermediate target parameter may be modulated by using the target expression modulation coefficient to generate the second target parameter.

Description is provided below by using an example in which the style-based generative adversarial network is used as the image generation model in the present disclosure. The style-based generative adversarial network first maps input latent code z (for example, the random vector that follows the Gaussian distribution) in a latent space Z to an intermediate latent space W through a mapping network (for example, a non-linear mapping network f: Z→W), thereby obtaining an intermediate vector w (w E W), that is, the first intermediate target parameter in the present disclosure. The mapping network is used to encode the input vector z as the intermediate vector w, and different elements of the intermediate vector w control different visual features. Then, the second target parameter may be obtained according to an equation 1 below:

$${w}^{′} = aw + b \qquad ( 1 )$$

Here, w′ represents the second target parameter, w represents the first intermediate target parameter, a represents the weight coefficient in the target expression modulation coefficient, and b represents the bias coefficient in the target expression modulation coefficient.

It should be noted that the image generation model in step S120 and the image generation model in step S150 may be the same model or identical models.

Step S260: extract a first non-expression coefficient based on the first image.

Step S270: extract, based on the second image, a second expression coefficient and a second non-expression coefficient.

Step S280: parametrically adjust the target model by using a loss function constructed based on the first non-expression coefficient, the target expression coefficient, the second non-expression coefficient, and the second expression coefficient.

In some embodiments, the parameter extractor, for example, an emotion capture and animation encoder, of the 3D deformation statistical model may be used to respectively extract the first non-expression coefficient from the first image and the second non-expression coefficient and the second expression coefficient from the second image.

In some embodiments, a non-expression coefficient is a coefficient other than an expression coefficient extracted from the image, such as a posture coefficient, a shape coefficient, or an image light and shade coefficient.

The first image is generated based on the first target parameter, and the second image is generated based on the first target parameter and the target expression coefficient. Therefore, on one hand, the expression coefficient (e.g., the second expression coefficient) extracted based on the second image is expected to be consistent with the target expression coefficient. On the other hand, the non-expression coefficient (e.g., the second non-expression coefficient) extracted based on the second image is expected to be consistent with the non-expression coefficient (e.g., the first non-expression coefficient) extracted based on the first image. Therefore, in the present disclosure, the target model is parametrically adjusted by using the loss function constructed based on the first non-expression coefficient, the target expression coefficient, the second non-expression coefficient, and the second expression coefficient, so that the adjusted target model can generate a target expression modulation coefficient meeting the expectation based on the target expression coefficient. In turn, after the second target parameter generated based on the first target parameter (or the first intermediate target parameter generated based on the first target parameter) and the target expression modulation coefficient is input into the image generation model, an image having an expected target expression can be obtained.

In a specific implementation, the target model may be parametrically adjusted by using a first loss function constructed based on the first non-expression coefficient and the second non-expression coefficient, and a second loss function constructed based on the target expression coefficient and the second expression coefficient.

In another specific implementation, a first normal map may be generated based on the first non-expression coefficient and the target expression coefficient, a second normal map may be generated based on the second non-expression coefficient and the second expression coefficient, and the target model may be parametrically adjusted by using a loss function constructed based on the first normal map and the second normal map. In this embodiment, a reconstruction constraint (for example, an L1-norm loss function) is performed by using the normal map rendered based on the expression coefficient and non-expression coefficient, and such an intuitive image-level constraint can enhance learning and optimization of the target expression.

The two implementations described above may alternatively be used together. For example, the same weight or a different weight may be set for each loss function, and the loss functions are weighted to obtain a total loss function. In this case, the target model is parametrically adjusted based on the total loss function.

According to one or more embodiments of the present disclosure, the first target parameter is input into the trained image generation model to generate the first image, the preset target expression coefficient is input into the target model to generate the target expression modulation coefficient, the second target parameter is generated based on the first target parameter and the target expression modulation coefficient and is input into the image generation model to generate the second image, and the target model is parametrically adjusted by using the loss function constructed based on the target expression coefficient, the first non-expression coefficient extracted from the first image, the second non-expression coefficient extracted from the second image, and the second expression coefficient, so that the adjusted target model can generate the target expression modulation coefficient meeting the expectation based on the target expression coefficient. This ultimately enables the entire model to generate images and target expression images of the images in batches.

In some embodiments, the target expression coefficient includes a neutral expression coefficient. For example, the neutral expression coefficient includes an all-zero vector. Neutral expression may also be referred to as de-expression that is intended to achieve an effect of changing an obvious expression on a to a less obvious expression, for example, changing an expression of an open mouth showing teeth to an expression of a closed mouth not showing teeth. In addition to being one of application scenarios of an expression change, the de-expression further has an additional application requirement. For example, in a process of processing an expression, it is difficult to add another expression to an image with expressive expressions (such as an expression of an open mouth showing teeth), and it is very likely to fail in processing. However, if the expression of the image is removed first (e.g., a neutral expression image is generated), and then it is easier to superimpose a new expression on the image on which the neutral expression is generated. In this regard, the inventors have found through experiments that the second image finally generated may meet a feature of the neutral expression by setting the target expression coefficient to the all-zero vector, so that the model provided in the present disclosure can have a capability to generate a neutral expression image, which is convenient for subsequent image processing.

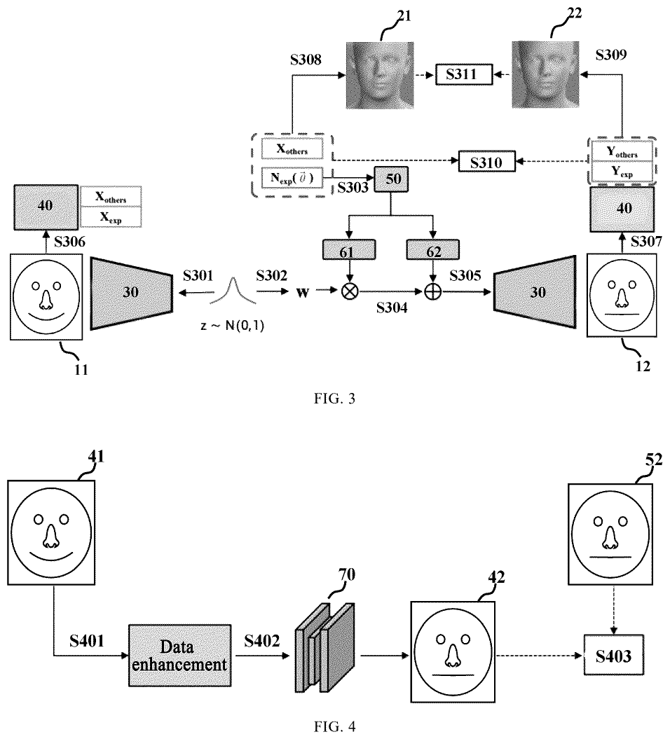

Referring to FIG. 3, FIG. 3 is a flowchart of a training method 300 of a target model according to another embodiment of the present disclosure. The method 300 includes step S301 to step S311.

In step S301, a randomly determined vector z that follows a Gaussian distribution is input into a pre-trained style-based generative adversarial network 30, to obtain a first image 11.

In step S302, the vector z is encoded as an intermediate vector w.

In step S303, a preset neutral expression coefficient is input into a target model to generate a neutral expression modulation coefficient. The target model includes a multi-layer perceptron 50, a convolutional neural network 61, and a convolutional neural network 62.

In step S304, the intermediate vector w is modulated based on the neutral expression modulation coefficient.

In step S305, a modulation result is input into the style-based generative adversarial network 30 to obtain a second image 12.

In step S306, by using a parameter extractor 40, such as an emotion capture and animation encoder, of a 3D deformation statistical model, parameters of the 3D deformation statistical model are extracted based on the first image, including a first expression coefficient Xₑₓₚ and a first non-expression coefficient Xₒₜₕₑᵣₛ.

In step S307, by using the parameter extractor 40, such as an emotion capture and animation encoder, of the 3D deformation statistical model, parameters of the 3D deformation statistical model are extracted based on the second image, including a second expression coefficient Yₑₓₚ and a second non-expression coefficient Y others.

In step S308, rendering is performed based on the first non-expression coefficient Xₒₜₕₑᵣₛ and a neutral expression coefficient Nₑₓₚ(0), to obtain a first normal map 21.

In step S309, rendering is performed based on the second non-expression coefficient Yₒₜₕₑᵣₛ and the second expression coefficient Yₑₓₚ, to obtain a second normal map 22.

In step S310 and step S311, the target model is parametrically adjusted by using a first reconstruction loss function constructed based on the first non-expression coefficient Xₒₜₕₑᵣₛ, the neutral expression coefficient Nₑₓₚ(0), the second non-expression coefficient Yₒₜₕₑᵣₛ, and the second expression coefficient Yₑₓₚ, and a second reconstruction loss function constructed based on the first normal map 21 and the second normal map 22.

For example, assuming that the first reconstruction loss function is loss 1 and the second reconstruction function is loss 2, a loss function of the target model may be obtained based on an equation 2 below:

$$loss = α \times loss 1 + β \times loss 2 \qquad ( 2 )$$

where α represents a weight corresponding to the first reconstruction loss function, and β represents a weight corresponding to the second reconstruction loss function.

In this embodiment, by using an image generation capability of the style-based generative adversarial network, in combination with a capability of the 3D deformation statistical model to perceive an expression (e.g., an facial expression), training may be performed to generate image pairs including images and target expression images of the images in batches.

In some embodiments, a target expression model may be trained by using, as sample data pairs, image pairs including the first images and the second images corresponding to the first images that are generated in batches by the model provided in the present disclosure. For example, the target expression model is trained by using the first image as an input of the target expression model and the second image as an output of the target expression model, so that a trained target expression model can have an image with a target expression based on the input image.

In some embodiments, a quantity of samples may be increased through data enhancement before the first image in a sample is input into the target expression model. For example, data enhancement may be performed by using a thin plate spline function.

Referring to FIG. 4, FIG. 4 is a flowchart of a training method 400 of a target expression model according to an embodiment of the present disclosure. The method 400 includes step S401 to step S403.

In step S401, a first image 41 may be processed based on a preset data enhancement function. The first image 41 may be the first image generated through step S101.

In step S402, a processed first image is input into a target expression model 70 to generate a predicted image 42.

In step S403, the target expression model 70 is trained based on a difference between the predicted image and a second image. For example, the second image 52 may be the second image generated through step S103. In some embodiments, reconstruction loss supervision and generative adversarial network loss supervision may be performed on the predicted image 41 and the second image 52, to train the target expression model 70.

In this way, a trained target expression model may generate an image with a target expression based on an image randomly input.

In some embodiments, the image is input into the trained target expression model, to obtain the image with the target expression. In this embodiment, a user may input a real image into the trained target expression model, so that the image with the target expression can be obtained, and a target expression effect can be added to the real image. For example, if the target expression model is a neutral expression model, an image from which an expression is removed may be obtained.

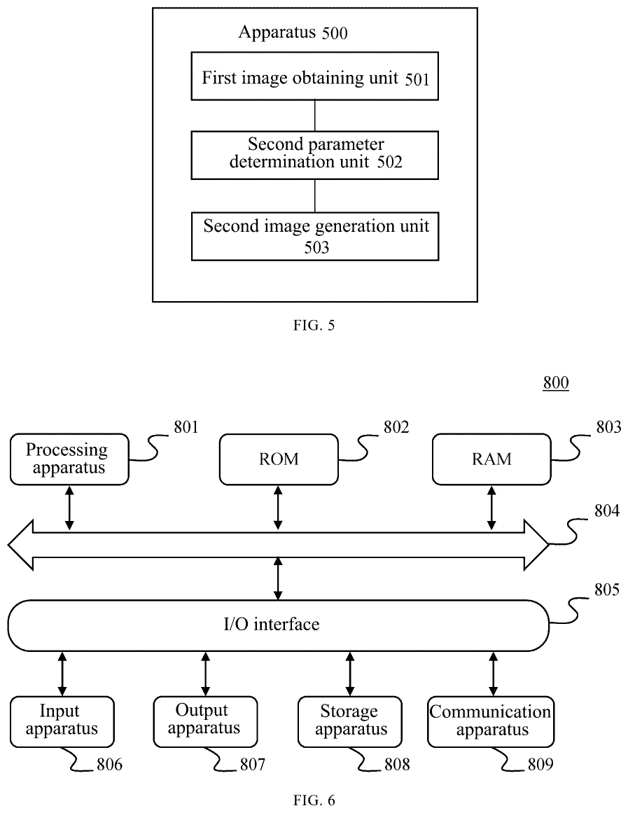

Accordingly, referring to FIG. 5, an image generation apparatus 500 according to an embodiment of the present disclosure includes:
a first image obtaining unit 501 configured to obtain a first image;
a second parameter determination unit 502 configured to generate a second target parameter based on a first target parameter corresponding to the first image and a target expression modulation coefficient; and
a second image generation unit 503 configured to input the second target parameter into an image generation model to generate a second image, where the second image is an image matching the first image and having a target expression.

In some embodiments, the first image obtaining unit is configured to input the first target parameter into the image generation model to obtain the first image.

In some embodiments, the target expression modulation coefficient is determined based on steps of: extracting a first non-expression coefficient based on the first image; extracting, based on the second image, a second expression coefficient and a second non-expression coefficient; adjusting a target model by using a loss function constructed based on the first non-expression coefficient, a target expression coefficient, the second non-expression coefficient, and the second expression coefficient; and inputting a preset target expression coefficient into the target model to generate the target expression modulation coefficient.

In some embodiments, adjusting the target model by using the loss function constructed based on the first non-expression coefficient, the target expression coefficient, the second non-expression coefficient, and the second expression coefficient includes: parametrically adjusting the target model by using a first loss function constructed based on the first non-expression coefficient and the second non-expression coefficient, and a second loss function constructed based on the target expression coefficient and the second expression coefficient; and/or generating a first normal map based on the first non-expression coefficient and the target expression coefficient, generating a second normal map based on the second non-expression coefficient and the second expression coefficient, and parametrically adjusting the target model by using a loss function constructed based on the first normal map and the second normal map.

In some embodiments, the target expression coefficient is determined based on steps of: obtaining a target image including the target expression; and extracting the target expression coefficient based on the target image.

In some embodiments, the target expression coefficient includes a neutral expression coefficient.

In some embodiments, the neutral expression coefficient includes an all-zero vector.

In some embodiments, the non-expression coefficient includes at least one of: a posture coefficient, a shape coefficient, or a light and shade coefficient.

In some embodiments, extracting a first non-expression coefficient based on the first image includes: extracting the first non-expression coefficient based on the first image by using a parameter extractor of a 3D deformation statistical model; and extracting a second expression coefficient and a second non-expression coefficient based on the second image includes: extracting the second expression coefficient and the second non-expression coefficient based on the second image by using the 3D deformation statistical model.

In some embodiments, the target expression modulation coefficient includes a weight coefficient and a bias coefficient.

In some embodiments, the second parameter determination unit is configured to generate a first intermediate target parameter based on the first target parameter and generate a second target parameter based on the first intermediate target parameter and the target expression modulation coefficient.

In some embodiments, the image generation apparatus further includes:
an expression model training unit configured to train the target expression model by using the first image as an input of the target expression model and the second image as an output of the target expression model, so that a trained target expression model can obtain an image with a target expression based on the input image.

In some embodiments, the image generation apparatus further includes:
a target expression obtaining unit, configured to input the image into the trained target expression model, to obtain the image with the target expression.

The apparatus embodiment is substantially corresponding to the method embodiment, and therefore for a related part, reference may be made to the descriptions of the part in the method embodiment. The apparatus embodiment described above is only illustrative, and the modules described as separate modules therein may or may not be separate. Some or all of the modules may be selected according to actual needs to achieve the objectives of the solutions of the embodiments, which can be understood and implemented by those of ordinary skill in the art without involving any inventive effort.

Accordingly, according to one or more embodiments of the present disclosure, an electronic device is provided. The electronic device includes:
at least one memory and at least one processor.

The memory is configured to store program code. The processor is configured to invoke the program code stored in the memory, so that the electronic device performs the image generation method according to one or more embodiments of the present disclosure.

Accordingly, according to one or more embodiments of the present disclosure, a non-transitory computer storage medium is provided. The non-transitory computer storage medium stores program code, that, when executed by a computer device, causes the computer device to perform the image generation method according to one or more embodiments of the present disclosure.

Reference is made to FIG. 6, which is a schematic diagram of a structure of an electronic device (such as a terminal device or a server) 800 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (for example, a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 800 may include a processing apparatus (e.g., a central processing unit or a graphics processing unit) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to one another through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 6 shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 809, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, a client and a server may communicate using any currently known or future-developed network protocol such as the hypertext transfer protocol (HTTP), and may be connected to digital data communication (for example, a communication network) in any form or medium. Examples of communication networks include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, an image generation method is provided. The method includes: obtaining a first image; generating, based on a first target parameter corresponding to the first image and a target expression modulation coefficient, a second target parameter; and inputting the second target parameter into an image generation model to generate a second image, where the second image is an image matching the first image and having a target expression.

According to one or more embodiments of the present disclosure, the obtaining a first image includes: inputting the first target parameter into the image generation model, to obtain the first image.

According to one or more embodiments of the present disclosure, the target expression modulation coefficient is determined based on steps of: extracting a first non-expression coefficient based on the first image; extracting, based on the second image, a second expression coefficient and a second non-expression coefficient; adjusting a target model by using a loss function constructed based on the first non-expression coefficient, a target expression coefficient, the second non-expression coefficient, and the second expression coefficient; and inputting a preset target expression coefficient into the target model to generate the target expression modulation coefficient.

According to one or more embodiments of the present disclosure, a training method of the target model includes: determining a first target parameter; inputting the first target parameter into a predetermined image generation model to generate a first image, where the image generation model is a trained model for generating an image based on an input parameter; inputting a preset target expression coefficient into the target model to generate the target expression modulation coefficient; generating a second target parameter based on the first target parameter and the target expression modulation coefficient; inputting the second target parameter into the image generation model to generate a second image. extracting a first non-expression coefficient based on the first image; extracting a second expression coefficient and a second non-expression coefficient based on the second image; and parametrically adjusting the target model by using a loss function constructed based on the first non-expression coefficient, the target expression coefficient, the second non-expression coefficient, and the second expression coefficient.

According to one or more embodiments of the present disclosure, parametrically adjusting the target model by using a loss function constructed based on the first non-expression coefficient, the target expression coefficient, the second non-expression coefficient, and the second expression coefficient includes: parametrically adjusting the target model by using a first loss function constructed based on the first non-expression coefficient and the second non-expression coefficient, and a second loss function constructed based on the target expression coefficient and the second expression coefficient; and/or generating a first normal map based on the first non-expression coefficient and the target expression coefficient, generating a second normal map based on the second non-expression coefficient and the second expression coefficient, and parametrically adjusting the target model by using a loss function constructed based on the first normal map and the second normal map.

According to one or more embodiments of the present disclosure, the target expression coefficient is determined based on steps of: obtaining a target image including the target expression; and extracting the target expression coefficient based on the target image.

According to one or more embodiments of the present disclosure, the target expression coefficient includes a neutral expression coefficient, and the neutral expression coefficient includes an all-zero vector.

According to one or more embodiments of the present disclosure, the non-expression coefficient includes at least one of: a posture coefficient, a shape coefficient, or a light and shade coefficient.

According to one or more embodiments of the present disclosure, extracting a first non-expression coefficient based on the first image includes: extracting the first non-expression coefficient based on the first image by using a parameter extractor of a 3D deformation statistical model; and extracting a second expression coefficient and a second non-expression coefficient based on the second image includes: extracting the second expression coefficient and the second non-expression coefficient based on the second image by using the 3D deformation statistical model.

According to one or more embodiments of the present disclosure, the target expression modulation coefficient includes a weight coefficient and a bias coefficient.

According to one or more embodiments of the present disclosure, generating, based on the first target parameter and the target expression modulation coefficient, a second target parameter, includes: generating a first intermediate target parameter based on the first target parameter; and generating the second target parameter based on the first intermediate target parameter and the target expression modulation coefficient.

According to one or more embodiments of the present disclosure, the image generation method further includes: training the target expression model by using the first image as an input of the target expression model and the second image as an output of the target expression model, so that a trained target expression model can obtain an image with a target expression based on the input image.

According to one or more embodiments of the present disclosure, the image generation method further includes: inputting the image into the trained target expression model, to obtain the image with the target expression.

According to one or more embodiments of the present disclosure, an image generation apparatus is provided. The apparatus includes: a first image obtaining unit configured to obtain a first image; a second parameter determination unit configured to generate a second target parameter based on a first target parameter corresponding to the first image and a target expression modulation coefficient; and a second image generation unit configured to input the second target parameter into an image generation model to generate a second image, where the second image is an image matching the first image and having a target expression.

According to one or more embodiments of the present disclosure, an electronic device is provided. The electronic device includes: at least one memory and at least one processor, where the memory is configured to store program code, and the processor is configured to invoke the program code stored in the memory to cause the electronic device to perform the image generation method according to one or more embodiments of the present disclosure.

According to one or more embodiments of the present disclosure, a non-transitory computer storage medium is provided. The non-transitory computer storage medium stores program code that, when executed by a computer device, causes the computer device to perform the image generation method provided in one or more embodiments of the present disclosure.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An image generation method, comprising:
obtaining a first image;
generating, based on a first target parameter corresponding to the first image and a target expression modulation coefficient, a second target parameter; and
inputting the second target parameter into an image generation model to generate a second image, wherein the second image is an image matching the first image and having a target expression.

2. The method according to claim 1, wherein obtaining a first image comprises:
inputting the first target parameter into the image generation model to obtain the first image.

3. The method according to claim 1, wherein the target expression modulation coefficient is determined based on steps of:
extracting a first non-expression coefficient based on the first image;
extracting, based on the second image, a second expression coefficient and a second non-expression coefficient;
adjusting a target model by using a loss function constructed based on the first non-expression coefficient, a target expression coefficient, the second non-expression coefficient, and the second expression coefficient; and
inputting a preset target expression coefficient into the target model to generate the target expression modulation coefficient.

4. The method according to claim 3, wherein adjusting the target model by using the loss function constructed based on the first non-expression coefficient, the target expression coefficient, the second non-expression coefficient, and the second expression coefficient comprises:
parametrically adjusting the target model by using a first loss function constructed based on the first non-expression coefficient and the second non-expression coefficient, and a second loss function constructed based on the target expression coefficient and the second expression coefficient; and/or
generating a first normal map based on the first non-expression coefficient and the target expression coefficient, generating a second normal map based on the second non-expression coefficient and the second expression coefficient, and parametrically adjusting the target model by using a loss function constructed based on the first normal map and the second normal map.

5. The method according to claim 3, wherein the target expression coefficient is determined based on steps of:
obtaining a target image comprising the target expression; and
extracting the target expression coefficient based on the target image.

6. The method according to claim 3, wherein the target expression coefficient comprises a neutral expression coefficient, and the non-expression coefficient comprises at least one of a posture coefficient, a shape coefficient, or a light and shade coefficient; and wherein the target expression modulation coefficient comprises a weight coefficient and a bias coefficient.

7. An electronic device, comprising:
at least one memory and at least one processor,
wherein the memory is configured to store program code, and the processor is configured to invoke the program code stored in the memory to causes the electronic device to:
obtain a first image;
generate, based on a first target parameter corresponding to the first image and a target expression modulation coefficient, a second target parameter; and
input the second target parameter into an image generation model to generate a second image, wherein the second image is a image matching the first image and having a target expression.

8. The electronic device according to claim 7, wherein when obtaining a first image, the electronic device is caused to:
input the first target parameter into the image generation model to obtain the first image.

9. The electronic device according to claim 7, wherein the target expression modulation coefficient is determined based on steps of:
extracting a first non-expression coefficient based on the first image;
extracting, based on the second image, a second expression coefficient and a second non-expression coefficient;
adjusting a target model by using a loss function constructed based on the first non-expression coefficient, a target expression coefficient, the second non-expression coefficient, and the second expression coefficient; and
inputting a preset target expression coefficient into the target model to generate the target expression modulation coefficient.

10. The electronic device according to claim 9, wherein when adjusting the target model by using the loss function constructed based on the first non-expression coefficient, the target expression coefficient, the second non-expression coefficient, and the second expression coefficient, the electronic device is caused to:
parametrically adjust the target model by using a first loss function constructed based on the first non-expression coefficient and the second non-expression coefficient, and a second loss function constructed based on the target expression coefficient and the second expression coefficient; and/or
generate a first normal map based on the first non-expression coefficient and the target expression coefficient, generate a second normal map based on the second non-expression coefficient and the second expression coefficient, and parametrically adjust the target model by using a loss function constructed based on the first normal map and the second normal map.

11. The electronic device according to claim 9, wherein the target expression coefficient is determined based on steps of:
obtaining a target image comprising the target expression; and
extracting the target expression coefficient based on the target image.

12. The electronic device according to claim 9, wherein the target expression coefficient comprises a neutral expression coefficient, and the non-expression coefficient comprises at least one of a posture coefficient, a shape coefficient, or a light and shade coefficient.

13. The electronic device according to claim 12, wherein the target expression modulation coefficient comprises a weight coefficient and a bias coefficient.

14. A non-transitory computer storage medium,
storing program code that, when executed by a computer device, causes the computer device to: obtain a first image;
generate, based on a first target parameter corresponding to the first image and a target expression modulation coefficient, a second target parameter; and
input the second target parameter into an image generation model to generate a second image, wherein the second image is a image matching the first image and having a target expression.

15. The non-transitory computer storage medium according to claim 14, wherein when obtaining a first image, the computer device is caused to:
input the first target parameter into the image generation model to obtain the first image.

16. The non-transitory computer storage medium according to claim 14, wherein the target expression modulation coefficient is determined based on steps of:
extracting a first non-expression coefficient based on the first image;
extracting, based on the second image, a second expression coefficient and a second non-expression coefficient;
adjusting a target model by using a loss function constructed based on the first non-expression coefficient, a target expression coefficient, the second non-expression coefficient, and the second expression coefficient; and
inputting a preset target expression coefficient into the target model to generate the target expression modulation coefficient.

17. The non-transitory computer storage medium according to claim 16, wherein when adjusting the target model by using the loss function constructed based on the first non-expression coefficient, the target expression coefficient, the second non-expression coefficient, and the second expression coefficient, the computer device is caused to:
parametrically adjust the target model by using a first loss function constructed based on the first non-expression coefficient and the second non-expression coefficient, and a second loss function constructed based on the target expression coefficient and the second expression coefficient; and/or
generate a first normal map based on the first non-expression coefficient and the target expression coefficient, generate a second normal map based on the second non-expression coefficient and the second expression coefficient, and parametrically adjust the target model by using a loss function constructed based on the first normal map and the second normal map.

18. The non-transitory computer storage medium according to claim 16, wherein the target expression coefficient is determined based on steps of:
obtaining a target image comprising the target expression; and
extracting the target expression coefficient based on the target image.

19. The non-transitory computer storage medium according to claim 16, wherein the target expression coefficient comprises a neutral expression coefficient, and the non-expression coefficient comprises at least one of a posture coefficient, a shape coefficient, or a light and shade coefficient.

20. The non-transitory computer storage medium according to claim 16, wherein the target expression modulation coefficient comprises a weight coefficient and a bias coefficient.
